(19) United States
(12) Patent Application Publication
(10) Pub. No.: US 2015/0362717 A1
(43) Pub. Date: Dec. 17, 2015

(54) MULTIPHOTON LUMINESCENCE EXCITATION MICROSCOPY UTILIZING DIGITAL MICROMIRROR DEVICE (DMD)

(71) Applicant: NATIONAL CHENG KUNG UNIVERSITY, Tainan City (TW)

(72) Inventors: Shean-Jen CHEN, Tainan City (TW); Jeng-Nan YIH, Tainan City (TW); Yong-Da SIE, Tainan City (TW); Yvonne Yuling HU, Tainan City (TW); Li-Chung CHENG, Tainan City (TW); Yi-Cheng LI, Tainan City (TW); Chia-Yuan CHANG, Tainan City (TW)

(73) Assignee: NATIONAL CHENG KUNG UNIVERSITY, Tainan City (TW)

(21) Appl. No.: 14/584,278

(22) Filed: Dec. 29, 2014

(30) Foreign Application Priority Data
Jun. 11, 2014 (TW) 103120148

(51) Int. Cl. G02B 21/36; G02B 21/04; G02B 21/00

(52) U.S. Cl. CPC G02B 21/361; G02B 21/0004; G02B 21/04

(57) ABSTRACT

A multiphoton luminescence excitation microscopy utilizing a digital micromirror device (DMD), wherein the multiphoton luminescence excitation microscopy generates luminescence excitation light information according to excitation of a sample, comprising an excitation light source, a plurality of lenses, a digital micromirror device (DMD), an objective lens, a dichroic mirror and a light detector. The DMD is utilized to replace the conventional diffraction grating of luminescence excitation microscopy The DMD has advantages of easy accessibility, relatively low cost, successfully achieves temporal-focusing at the image formation plane, and the grating effect.

### FIELD OF THE INVENTION

The invention relates to luminescence excitation microscopy, and more particularly to utilizing a digital micromirror device (MID) to replace the conventional diffraction grating of luminescence excitation microscopy, with advantages of easy accessibility, relatively low cost, and successfully achieves temporal-focusing at the image formation plane, and may have the grating effect.

### BACKGROUND OF THE INVENTION

Excitation light microtechnique can be used to quickly and accurately analyze the energy level and carrier transition of a sample. It is used in optical luminescence technology and basic optical measurement technology.

Widefield temporal-focusing multiphoton luminescence excitation microtechnique is used for image detection and processing. It can achieve high-speed image scanning and avoid prolonged exposure to laser light induced photochemical destruction by widefield function. In addition, the use of the same characteristics can be detected in vivo luminescence excitation, and is widely used in clinical medicine.

However, widefield temporal-focusing multiphoton luminescence excitation microtechnique uses a grating as a spectroscopic and diffraction element. The conventional grating has such disadvantages as has high cost and cannot provide an effective excitation area of the non-specific graphics.

In view of the foregoing, a need exists in the art for an improved widefield temporal-focusing multiphoton luminescence excitation microtechnique.

### SUMMARY OF THE INVENTION

Accordingly, to solve the above problems, an object of the present invention is to provide a multiphoton luminescence excitation microscopy that utilizes a DMD to replace the conventional diffraction grating of luminescence excitation microscopy.

The DMD has numerous advantages such as easy accessibility, relatively low cost, successfully achieves temporal-focusing at the image formation plane, and the grating effect.

In order to accomplish the above objective and more, the present invention provides a multiphoton luminescence excitation microscopy utilizing a digital micromirror device (DMD), wherein the multiphoton luminescence excitation microscopy generates luminescence excitation light information according to excitation of a sample, at least comprising: an excitation light source for generating an excitation light; a plurality of lenses for adjusting the excitation light that passes through the plurality of lenses; a digital micromirror device (DMD) for reflecting the excitation light that passes through the plurality of lenses, and lets the excitation light frequency expand and adjust the excitation light graphics; an objective lens for focusing the excitation light that reflection on the DMD to a spot, the spot excites the sample and receives the luminescence excitation light information produced by the sample; a dichroic mirror for filtering specific wavelengths of the luminescence excitation light information; and a light detector for detecting the luminescence excitation light information that passes through the dichroic mirror.

The present invention provides a modified multiphoton excitation microscopy system in which the conventional diffraction grating is replaced by a DMD. This configuration shows that the lateral resolution is almost as high as that of a setup based on a 600 lines/mm diffraction grating. Moreover, the axial confinement results obtained for a thin luminescence film demonstrate the sectioning ability of the proposed configuration. Overall, the results presented in the present invention show that the DMD provides a practical solution for simultaneously diffracting the frequencies of the illuminating light and generating image patterns for further processing.

### BRIEF DESCRIPTION OF THE DRAWINGS

FIG. 1 is a first schematic view of a preferred embodiment of the present invention;

FIG. 2 is a second schematic view of a preferred embodiment of the present invention;

FIG. 3 is a third schematic view of a preferred embodiment of the present invention;

FIG. 4 is a forth schematic view of a preferred embodiment of the present invention; and

FIG. 5-1˜5-4 are fifth to eighth schematic views of a preferred embodiment of the present invention.

### DETAILED DESCRIPTION OF THE INVENTION

In order to describe details of preferred embodiments of the present invention, description of the structure, and the application as well as the steps are made with reference to the accompanying drawings. It is learned that after the description, any variation, modification or the like to the structure and the steps of the embodiments of the preferred embodiment of the present invention is easily made available to any person skilled in the art. Thus, the following description is only for illustrative purpose and does not, in any way, try to limit the scope of the present invention.

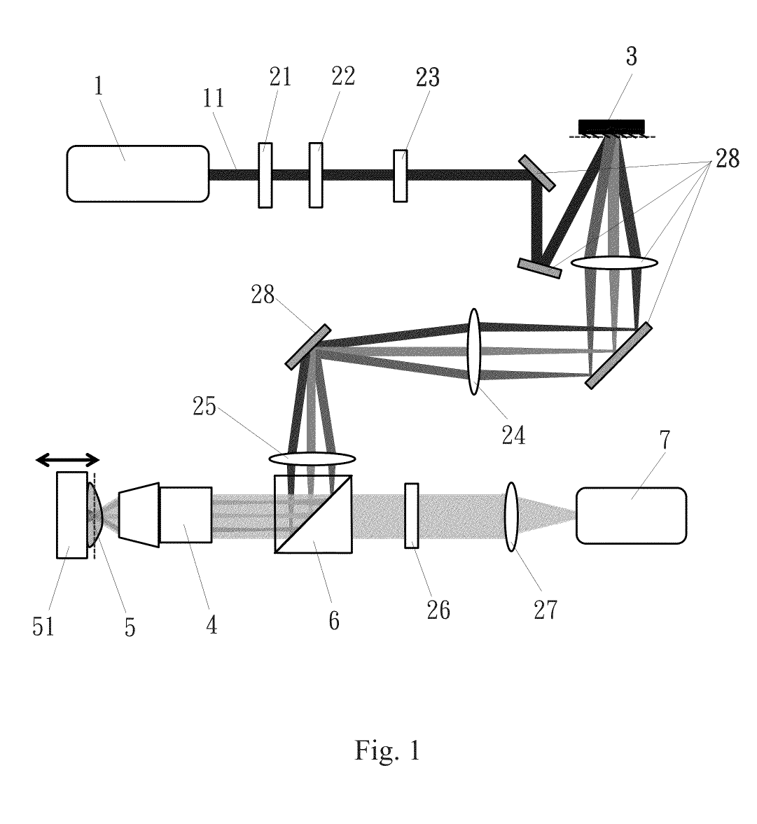

With reference to FIG. 1 of a preferred embodiment of the present invention, which illustrates a multiphoton luminescence excitation microscopy utilizing a digital micromirror device 3 (DMD), wherein the multiphoton luminescence excitation microscopy generates luminescence excitation light information according to an excited sample 5, at least comprising an excitation light source 1, a plurality of lenses, a DMD 3, an objective: lens 4, a dichroic mirror 6 and a light detector 7.

The excitation light source 1 is used for generating an excitation light 11.

The plurality of lenses are used for adjusting the excitation light 11 that passes through the plurality of lenses. Preferably, the plurality of lenses at least comprises a plane 21 for adjusting strength of the excitation light 11, and a polaroid 22 for adjusting the polarizationngle of the excitation light 11. In this embodiment the plane 21 is a half-wave plate 21 and the polaroid 22 is a linear polaroid 22.

The DMD 3 reflects the excitation light 11 that passes through the plurality of lenses, and lets the excitation light 11 frequency expand and adjust the excitation light 11 graphics.

The objective lens 4 focuses the excitation light 11 that reflects on the DMD 3 to a spot. The spot excites the sample 5 and receives the luminescence excitation light information that is produced by the sample 5.

The dichroic mirror 6 filters specific wavelengths of the luminescence excitation light information.

The light detector 7 detects the luminescence excitation light information that passes through the dichroic mirror 6. In an embodiment of the present invention the light detector 7 is an electron multiplying charge couple device (EMCCD).

In a preferred embodiment, the present invention further comprises a control shutter 23, a relay lens 24, a collimating lens 25, a short wavelength filter 26, an image formation lens 27, an electric mobile stage 51, and a plurality of refractors 28.

The control shutter 23 changes exposure of the excitation light 11.

The relay lens 24 receives the excitation light 11 that is reflected from the DMD 3. The relay lens 24 may extend an optical path and let the excitation light fully pass through the incident aperture of the objective lens 4 after the frequency expands, so that the excitation light 11 on the sample 5 completely achieves temporal-focusing.

The collimating lens 25 receives the excitation light 11 that passes through the relay lens 24 and exports the excitation light 11 in parallel.

The short wavelength filter 26 receives the luminescence excitation light information that passes through the dichroic mirror 6 and allows a short wavelength of the luminescence excitation light information to pass through.

The image formation lens 27 receives the luminescence excitation light information that passes through the dichroic mirror 6, and allows the luminescence excitation light information image to form at the light detector 7.

The electric mobile stage 51 adjusts the sample 5 to obtain 3D images.

The plurality of refractors 28 controls the direction of the excitation light 11.

According to the above structure, the excitation light 11 that is generated by the excitation light source 1 passes through the half-wave plate 21 and the linear polaroid 22. The half-wave plate 21 and the linear polaroid 22 adjust the strength and the polarization angle of the incident light (excitation light 11). The incident light has different diffraction angles and causes different frequencies when radiating into the DMD 3. Preferably, the present invention utilizes a central wavelength (750 nm) with 0° of diffraction, thus the incident angle is twice as the mirror angle of the DMD 3. The relay lens 24 extends an optical path and allows the excitation light 11 to fully pass through the incident aperture of the objective lens 4 after frequency expansion, so that the excitation light 11 on the sample 5 achieves temporal-focusing completely. Then the collimating lens 25 exports the excitation light 11 parallel to the objective lens 4. In the present invention, the objective lens 4 not only focuses the excitation light 11 that reflects on the DMD 3 to a spot, but also receives the luminescence excitation light information that is produced by the sample 5. By the dichroic minor 6 and the short wavelength filter 26, a shorter wavelength luminescence excitation light information may pass through the image formation lens 27 and radiate into the EMCCD. The EMCCD detects the shorter wavelength luminescence excitation light information, wherein the control shutter 23 changes exposure of the excitation light 11 and obtains 3D images by adjusting the electric mobile stage 51. As a result a 3D stereoscopic image is obtained by overlapping the 3D images.

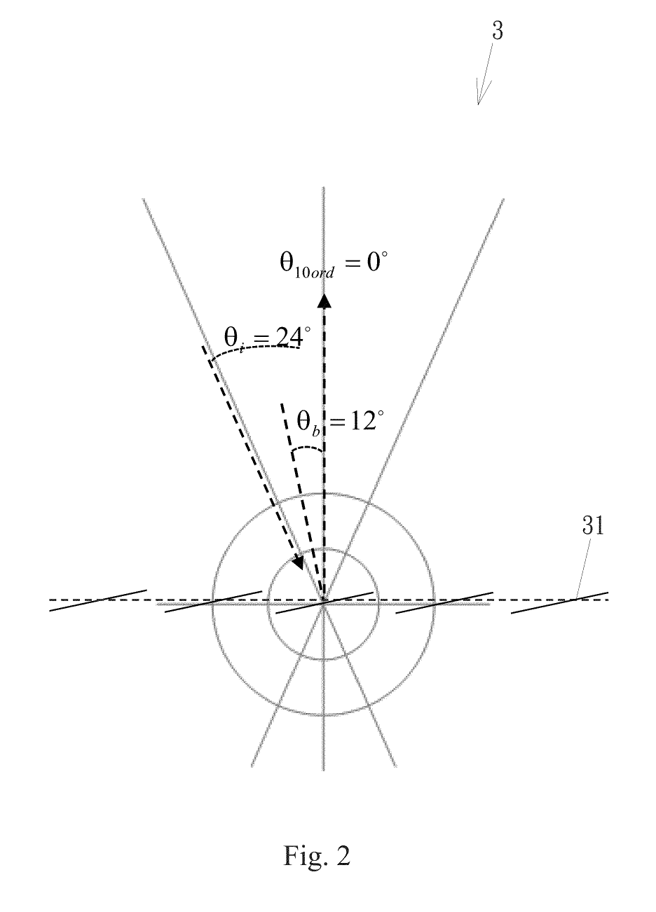

Refer to FIG. 2, which is an operation schematic view of the DMD 3. The DMD 3 uses a plurality of micromirrors 31 as a diffractive element to replace a diffractive grating. The plurality of micromirrors 31 forms an angle of operation as the diffractive grating angle and generates excellent tenth-order diffraction on the optical axis.

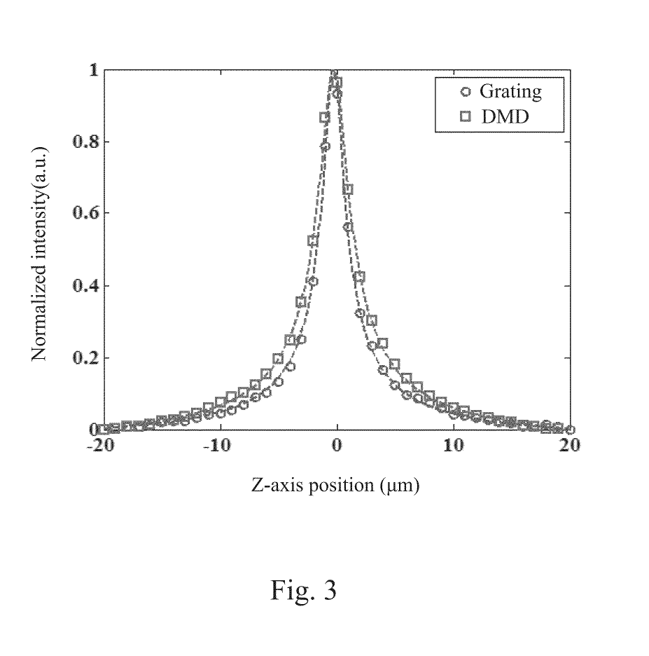

With reference to FIG. 3 of the present invention, the sectioning result comparison uses a 600 lines/mm diffraction grating and uses the DMD 3 of a temporal-focusing multiphoton luminescence excitation microscopy. As shown in the figure the diffraction grating and the DMD 3 have respective lateral resolving ability of about 3 and 4 microns by full wave at half maximum (FWHM).

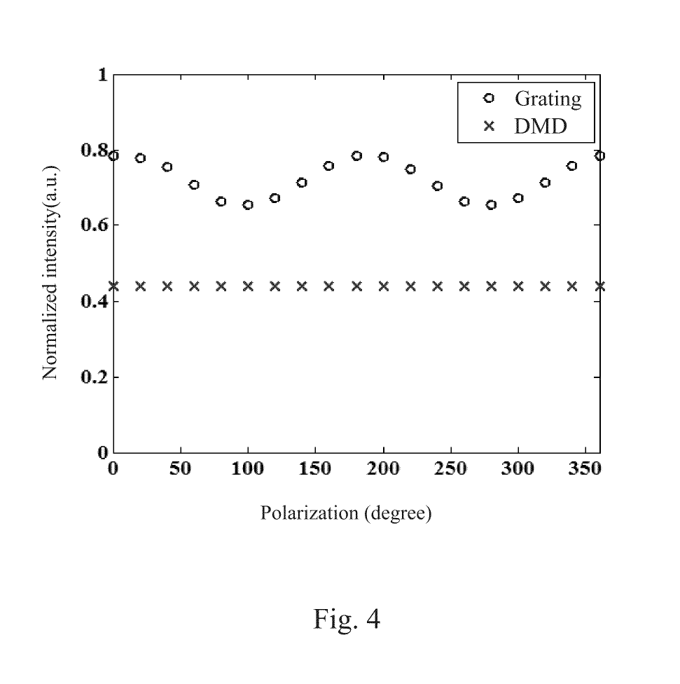

Refer to FIG. 4, which illustrates a comparison of reflecting efficiency of the diffraction grating and the DMD 3 for different polarization lights.

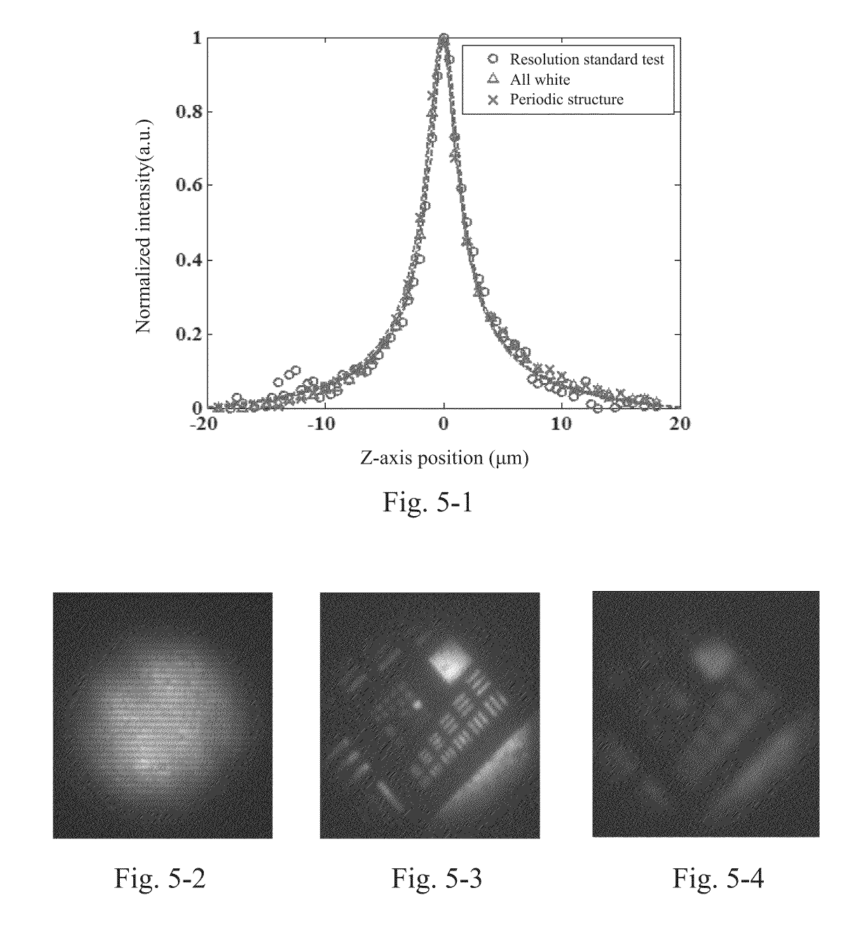

Refer to FIGS. 5-1 to 5-4 of the present invention, which illustrate image resolution of using the DMD 3 as a system component. FIG. 5-1 is a comparison of lateral resolving ability with the different graphics grating. FIGS. 5-2 to 5-4 are the imaging results at the sample 5 surface using the DMD 3 as the different graphics grating. There is little difference of spectroscopic capability between different graphics of the grating and the DMD 3. The DMD 3 also can provide lateral resolution.

The present invention utilizes the DMD as a diffractive element. The conventional widefield temporal-focusing multiphoton luminescence excitation microtechnique is according to the principle of Fourier optics to make the incident light of the diffractive element conjugate at the sample surface for providing the widefield effect. Then the diffractive element is utilized for frequency expansion of the incident light, and an objective lens is used to achieve temporal-focusing of different frequencies of incident light to provide the ability of sectioning.

The present invention utilizes the characteristic of the DMD. The characteristic uses the ON/OFF mode to represent the central axis flip +/−12°. The angle is used as the obliquity of the diffraction grating. According to the law of reflection, the incident light uses twice the angle as the roughly incident angle. Therefore, the diffraction angle of the center wavelength of the incident light may be zero. Fine tuning the incident angle generates excellent tenth-order diffraction.

Moreover, the DMD applied at visible light wavelengths can provide roughly 90% reflection efficiency to enhance the luminescence excitation efficiency. The incident light image formation on the sample by the original structure, and the image formation plane of the sample and the projection plane of the DMD conjugate to each other. Thus the DMD may replace the diffraction grating, providing an ability of sectioning and reconstructing a 3D image of the sample.

Research shows that the diffraction ability of different graphics gratings is no significant difference. Different graphics gratings can achieve the same image formation and the sectional effect. The DMD can be used as a projection screen for enhancing the image resolution and replaces the diffraction grating (Structured illumination microscopy, HiLo microscopy . . . etc.)

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A multiphoton luminescence excitation microscopy utilizing a digital micromirror device (DMD), wherein the multiphoton lug inescence excitation microscopy generates luminescence excitation light information according to excitation of a sample, at least comprising:
an excitation light source for generating an excitation light;
a plurality of lenses for adjusting the excitation light that passes through the plurality of lenses;
a digital micromirror device (DMD) for reflecting the excitation light that passes through the plurality of lenses, and allows frequency of the excitation light to expand and adjust excitation light graphics;
an objective lens for focusing the excitation light that reflects on the DMD to a spot, the spot excites the sample and receives the luminescence excitation light information that is produced by the sample;
a dichroic for filtering specific wavelengths of the luminescence excitation light information; and
a light detector for detecting the luminescence excitation light information that passes through the dichroic mirror.

2. The multiphoton luminescence excitation microscopy utilizing a DMD as claimed in claim 1, wherein the plurality of lenses at least comprises:
a plane for adjusting strength of the excitation and
a polaroid for adjusting polarization angle of the excitation light.

3. The multiphoton luminescence excitation microscopy utilizing a DMD as claimed in claim 2, wherein the plane is a half-wave plate.

4. The multiphoton luminescence excitation microscopy utilizing a DMD as claimed in claim 2, wherein the polaroid is a linear polaroid.

5. The multiphoton luminescence excitation microscopy utilizing a DMD as claimed in claim 1 further comprising a control shutter 23 for changing exposure of the excitation light.

6. The multiphoton luminescence excitation microscopy utilizing a DMD as claimed in claim 1 further comprising:
a relay lens for receiving the excitation light that is reflected from the DMD, the relay lens extends an optical path and lets the excitation light to fully pass through the incident aperture of the objective lens after frequency expansion, so that the excitation light on the sample achieves temporal-focusing completely; and
a collimating lens for receiving the excitation light that passes through the relay lens and exports the excitation light in parallel.

7. The multiphoton luminescence excitation microscopy utilizing a DMD as claimed in claim 1 further comprising:
a wavelength filter for receiving the luminescence excitation light information that passes through the dichroic mirror and allows a short wavelength of the luminescence excitation light information to pass through.

8. The multiphoton luminescence excitation microscopy utilizing a DMD as claimed in claim 1 further comprising:
an image formation lens for receiving the luminescence excitation light information that passes through the dichroic mirror, and allows for luminescence excitation light information image formation at the light detector.

9. The multiphoton luminescence excitation microscopy utilizing a DMD as claimed in claim 1, wherein the light detector is an electron multiplying charge couple device (EMCCD).

10. The multiphoton luminescence excitation microscopy utilizing a DMD as claimed in claim 1 further comprising:
an electric mobile stage for adjusting the sample to obtain 3D images.
